(19) United States
(12) Patent Application Publication
(10) Pub. No.: US 2007/0047401 A1
(43) Pub. Date: Mar. 1, 2007

(54) Optical system for collimating elliptical light beam and optical device using the same

(75) Inventor: Wen-Hsin Sun, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/453,457

(22) Filed: Jun. 14, 2006

(30) Foreign Application Priority Data
Aug. 26, 2005 (CN) 200510036919.7

(51) Int. Cl. G11B 7/00

(52) U.S. Cl. 369/44.23

(57) ABSTRACT

An optical system (20) for efficiently collimating an elliptical light beam includes a light source (21), a first lens (22), a second lens (23), and a third lens (24). The light source is adapted for providing an elliptical light beam defining different diverging angles in different directions, wherein any cross-section of the elliptical light beam emitted from the light source defines a long axis and a short axis which are perpendicular to each other. The first lens, the second lens, and the third lens are used for reconfiguring the elliptical light beam, thus obtaining a round light beam having equivalent short axis and long axis, and equivalent diverging angles in both horizontal direction and vertical direction. Optical centers of the first lens, the second lens, and the third lens commonly define a common optical axis along which the elliptical light beams travels.

### BACKGROUND OF THE INVENTION

1. FIELD OF THE INVENTION

The present invention relates to an optical system for collimating an elliptical light beam, and particularly to an optical system for efficiently collimating elliptical light beams emitted from a side light emitting laser diode and an optical device using the same.

2. Related Art

Optical disks are widely used data storing media, and are being developed to store more information than previous. Since higher data storing density is demanded of optical disks, optical disk reading/writing systems correspondingly need to be more precise and sophisticated.

Referring to FIG. 1, a conventional optical device 100 for providing a collimated parallel round light beam for reading/writing to a recording layer 150 of an optical disk (not shown) is shown. The optical device 100 includes a light source 110, a first round collimating lens 120, a beam splitter 130, an object lens 140, a second round collimating lens 160, and an optoelectronic detector 170. In operation, the light source 110 provides a light beam of a certain wavelength. The light beam is collimated by the first round collimating lens 120 into a parallel light beam. The parallel light beam is then transmitted through the beam splitter 130 to the object lens 140. The object lens 140 converges the parallel light beam to the recording layer 150 of the optical disk. The light beam converged to the recording layer 150 is modulated in accordance with the data recorded thereon or written thereon, and is then reflected by the optical disk back to the object lens 140. The light is then transmitted back to the beam splitter 130, and is then reflected thereby to the second round collimating lens 160. Therefore, the light beam is transmitted to and detected by the optoelectronic detector 170, rather than being transmitted to the light source 110. According to the light beam received, the optoelectronic detector 170 outputs an electronic signal, from which the information recorded on or written to the optical disk can be interpreted or identified.

A typical optical system adopts a side light emitting laser diode as a light source. Referring to FIG. 2, such a side light emitting laser diode 9 has a rectangular waveguide type resonation cavity. The laser light beam emitted from the resonation cavity has different diverging angles in horizontal directions and vertical directions respectively, and thus provides an elliptical light beam having an elliptical section 112. Typically, the horizontal diverging angle is about ±10° and the vertical diverging angle is about ±30°. An elliptical light beam has to be intercepted or converted to a round light beam for use in the optical system.

In the above-described optical device 100, the round collimating lens 120 is employed for intercepting a round core part 114 of the elliptical light beam and thus obtaining a round light beam. The collimating lens 130 generally has a diameter shorter than a corresponding short (e.g., horizontal) axis of a light spot projected by the elliptical light beam incident thereon. The core part of the elliptical light beam is allowed to pass through the round collimating lens 120, and the peripheral part of the elliptical light beam is dissipated. Referring to FIG. 3, this is a graph of a relationship between diverging angles of the elliptical light beam output by the side light emitting laser diode (X-axis) and intensity of light output by the collimating lens 130 (Y-axis). Various different horizontal diverging angles are collectively shown as the line θH, and various different vertical diverging angles are collectively shown as the line θv. The space between any two horizontally opposite points on the line θH represents the round core part of the elliptical light beam that is intercepted by the round collimating lens 130. The. horizontal space between each such point and the corresponding point on the line θv represents a peripheral part of the elliptical light beam that is dissipated. As seen in FIGS. 2 and 3, even if the round collimating lens 120 intercepts the elliptical light beam with a minimal amount of loss of light intensity (i.e. when both of the diverging angles are small), the amount of loss of light intensity is still quite large. Therefore, in general, a side light emitting laser diode with high power is needed to compensate for the loss of light intensity. However, high-power laser diodes are not only more costly, but also consume more power.

Therefore, what is needed is an optical system for efficiently collimating an elliptical light beam.

### SUMMARY

An exemplary embodiment of the present optical system is for efficiently collimating an elliptical light beam and providing a substantially round light beam for reading/writing to an optical disk.

The optical system includes a light source, a first lens, a second lens and a third lens arranged in that sequence. The light source is adapted for providing an elliptical light beam defining different diverging angles in different directions. In particular, any cross-section of the elliptical light beam emitted from the light source defines a long axis and a short axis, which are perpendicular to each other. The first lens is configured for collimating the elliptical light beam into a parallel elliptical light beam. The second lens is configured as a diverging lens in directions corresponding to the short axis, thus diverging the elliptical light beam and enlarging the short axis so as to narrow a difference between the long axis and the short axis and to narrow a difference between a diverging angle corresponding to the short axis and a diverging angle corresponding to the long axis, when the elliptical light beam passes therethough. The third lens is configured as a converging lens in the directions corresponding to the short axis, for converging the elliptical light beam and adjusting the short axis in order to obtaining a round light beam. A common optical axis is defined by the optical centers of the first lens and the second lens, and the elliptical light beams travels along the common optical axis.

An advantage of the optical system is that it can efficiently collimate the elliptical light beam emitting from the light source.

Another advantage is that a light source of relatively low power can be used in the optical system.

### BRIEF DESCRIPTION OF THE DRAWINGS

The above-mentioned and other features and advantages of the optical system, and the manner of attaining them, will become more apparent and the invention will be better understood by reference to the following description of embodiments thereof taken in conjunction with the accompanying drawings.

FIG. 1 is a schematic, front view of a conventional optical device for reading/writing to an optical disk, and also showing part of an optical disk and essential optical paths.

FIG. 2 is an enlarged, isometric view of a conventional light emitting laser diode, showing a diverging path of a light beam emitted therefrom.

FIG. 3 is a graph showing a relationship between diverging angles of light emitted by a light emitting laser diode of the optical device of FIG. 1 (X-axis) versus light intensity output by a round collimating lens of the optical device (Y-axis).

FIGS. 4A and 4B are schematic, respectively top view and front view of an optical system for collimating elliptical light beams according to an exemplary embodiment of the present invention, showing essential optical paths thereof.

FIG. 5 is a schematic, front view of an optical device for reading/writing to an optical disk, the optical device employing the optical system of FIG. 4, and also showing an optical disk and essential optical paths.

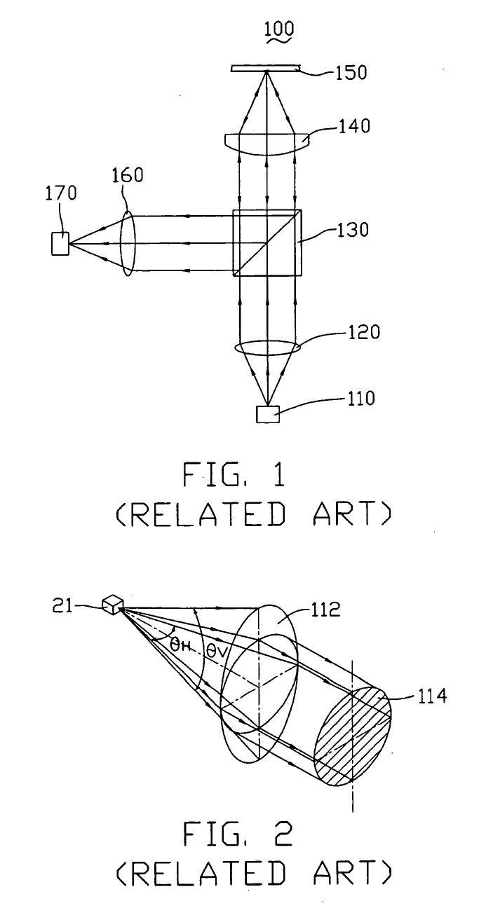

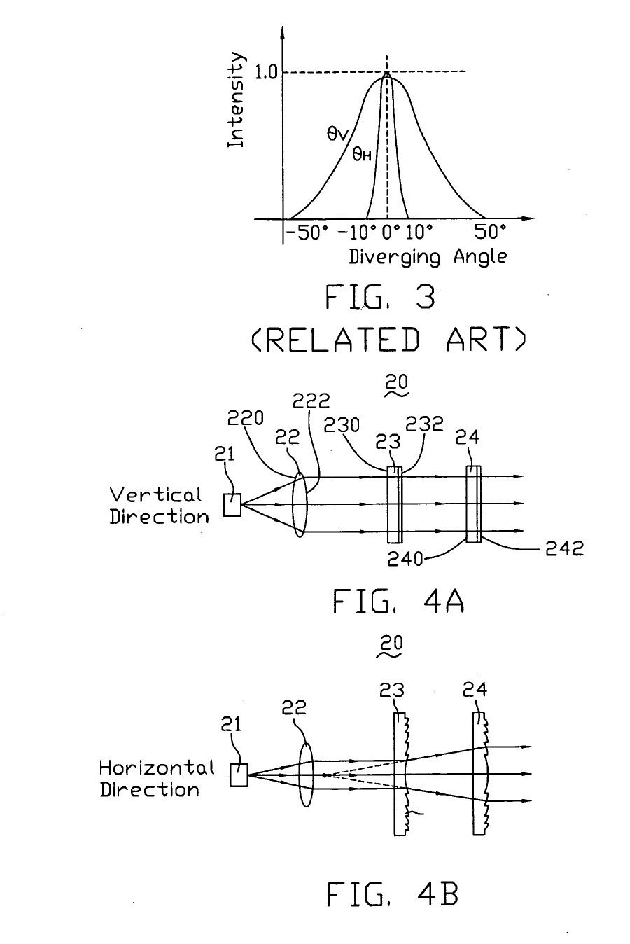

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF PREFERRED EMBODIMENTS

Reference will now be made to the drawings to describe in detail the preferred embodiments of the present optical system and an optical device using the same.

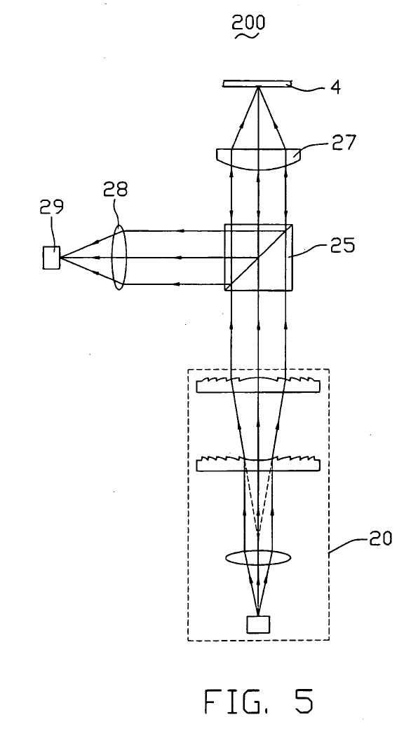

Referring to FIG. 4A, this is a schematic, top view of an optical system 20 for collimating elliptical light beams according to an exemplary embodiment of the present invention. The optical system 20 includes a light source 21, a first lens 22, a second lens 23, and a third lens 24 arranged in that sequence. The light source 21 is adapted for emitting an elliptical light beam along a path coinciding with optical centers of the first lens 22, the second lens 23 and the third lens 24. Any cross-section of the elliptical light beam emitted from the light source 21 defines a long axis and a short axis, which are perpendicular to each other. The elliptical light beam also defines different diverging angles in different directions. In the illustrated embodiment, the maximum diverging angle is in a vertical direction and the minimum diverging angle is in a horizontal direction. Thus in FIG. 4A, the long axis is coplanar with the page, and the short axis is perpendicular to the page. According to an embodiment shown in FIG. 4A, the optical system 20 is configured for collimating the diverged elliptical light beam emitted from the light source 21 while remaining the long axis thereof unchanged, and outputting a substantially round light beam therefrom.

Referring to FIG. 4B, it illustrates a front view of the optical system 20 of FIG. 4A. The first lens 22 is a collimating lens, configured for collimating light beams emitted from the light source 21 into parallel light beams. Thus the first lens 22 substantially functions as a diverging lens in horizontal directions. The second lens 23 is a Fresnel lens having two surfaces 230 and 232 opposite to each other. At least one of the two surfaces 230 and 232 is configured as a Fresnel diverging surface for diverging light beams incident from the horizontal direction. In the illustrated embodiment, the surface 232 is a diverging surface, and the surface 230 is a flat surface. Thus the second lens 23 substantially functions as a diverging lens in horizontal directions. The third lens 24 is also a Fresnel lens having two surfaces 240 and 242 opposite to each other. At least one of the two surfaces 240 and 242 is configured as a Fresnel converging surface for converging light beams incident from the horizontal direction. In the illustrated embodiment, the surface 242 is a converging surface and the surface 240 is a flat surface. Thus the third lens 24 substantially functions as a converging lens in horizontal directions. According to an embodiment shown in FIG. 4B, the optical system 20 is configured for collimating the diverged elliptical light beam emitted from the light source 21 while enlarging the short axis of the elliptical light beam, and outputting a substantially round light beam therefrom.

In use, the light source 21 emits an elliptical light beam having a short axis configured in horizontal directions coplanar with the page of FIG. 4. The first lens 22 collimates the elliptical light beam into a parallel elliptical light beam. The second lens 23 diverges the elliptical light beam and enlarges the short axis and/or the diverging angle in horizontal directions of the elliptical light beam. Thus when the diverged elliptical light beam reaches the third lens 24, a difference between the short axis and the long axis is narrowed. Meanwhile a difference between diverging angles of the elliptical light beam respectively in the horizontal directions and the vertical directions is narrowed. The third lens 24 converges the elliptical light beam and adjusts the short axis and/or the diverging angle in horizontal directions, thus providing a light beam having substantially round cross-sections and diverging angles approaching zero. The round light beam outputted from the third lens 24 is then ready for further use in a reading/writing operation.

The light source 21 is a side light emitting laser diode which has a rectangular waveguide type resonation cavity (not shown), from which the elliptical light beam can be emitted. According to the exemplary embodiment, the first lens 22, the second lens 23 and the third lens 24 advantageously have a common optical axis, along which the elliptical light beam emitted from the light source 21 is transmitted. The precise positions of the light source 21, the first lens 22, the second lens 23 and the third lens 24 relative to each other are determined according to need. For example, the optical system 20 may be structured so that the positions of any of lenses 22, 23 and 24 can be adjusted as required. That is, the positions of the lenses 22, 23 and 24 can be adjustable along the common optical axis. Thereby, the obtained parallel round light beam is tunable according to the requirements of any desired application.

In summary, the optical system 20 is adapted for efficiently utilizing the light energy of a side light emitting laser diode. Thus in the exemplary embodiment, the efficiency of utilization of light emitted by the light source 21 is improved.

An exemplary optical device 200 employing the optical system 20 is shown in FIG. 5. The optical device 200 is for reading/writing to an optical disk 4. The optical device 200 includes the optical system 20, a beam splitter 25, an object lens 27, a collimator 28, and an optoelectronic detector 29. The beam splitter 25 is configured for allowing light beams from a first direction to pass therethrough and for reflecting light beams from a second direction, the second direction being substantially opposite to the first direction. The object lens 27 is configured for focusing light beams passed therthrough. The optoelectronic detector 29 is configured for receiving a light beam, detecting information from the light beam, converting the information into electronic signals and outputting the electronic signals.

In operation, the optical system 20 provides a collimated parallel round light beam to the beam splitter 25. The parallel round light beam then passes through the beam splitter 25 to the object lens 27. The object lens 27 focuses the parallel light beam onto a point on the optical disk 4 set at a focal plane of the object lens, for reading data therefrom and/or writing data thereto. The light beam is modulated by the optical disk 4 according to the data recorded or the data to be written thereto, and then is reflected back to the object lens 27. The object lens 27 converts the light beam into a parallel light beam corresponding to information read from or written to the optical disk 4. The parallel light beam is then reflected by the beam splitter 25, and is then focused by the collimator 28 onto the optoelectronic detector 29. The optoelectronic detector 29 is adapted for detecting information from the light beam received, converting such information into electronic signals, and outputting the electronic signals.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. An optical system for collimating elliptical light beams, comprising:
a light source, adapted for providing an elliptical light beam defining different diverging angles in different directions, wherein any cross-section of the elliptical light beam emitted from the light source defines a long axis and a short axis which are perpendicular to each other;
a first lens, configured for collimating the elliptical light beam into a parallel elliptical light beam;
a second lens, configured as a diverging lens in directions corresponding to the short axis, for diverging the elliptical light beam and enlarging the short axis so as to narrow a difference between the long axis and the short axis and to narrow a difference between a diverging angle corresponding to the short axis and a diverging angle corresponding to the long axis, when the elliptical light beam passes therethough; and
a third lens, configured as a converging lens in the directions corresponding to the short axis, for converging the elliptical light beam and adjusting the short axis in order to obtaining a round light beam,
wherein the optical centers of the first lens, the second lens and the third lens commonly define a common optical axis along which the elliptical light beams travels.

2. The optical system as described in claim 1, wherein the second lens is a Fresnel lens having two surfaces opposite to each other, at least one of the two surfaces being configured as a Fresnel diverging surface configured for diverging light beams incident thereon.

3. The optical system as described in claim 1, wherein the third lens is a Fresnel lens having two surfaces opposite to each other, at least one of the two surfaces being configured as a Fresnel converging surface configured for converging light beams incident thereon.

4. The optical system as described in claim 1, wherein the relative positions of the light source, the first lens, the second lens, and the third lens are adjustable along the common optical axis.

5. The optical system as described in claim 1, wherein the light source, the first lens, the second lens, and the third lens are arranged in that order.

6. The optical system as described in claim 1, wherein the light source is a side light emitting laser diode.

7. The optical system as described in claim 2, wherein the second lens is configured for enlarging the short axis of the elliptical light beam incident thereon and remaining the long axis of the elliptical light beam unchanged.

8. The optical system as described in claim 3, wherein the third lens is configured for adjusting the diverging angle corresponding to the short axis of the elliptical light beam incident thereon and remaining the diverging angle corresponding to the long axis of the elliptical light beam unchanged.

9. An optical device for reading/writing to an optical disk, comprising:
an optical system configured for outputting a round parallel light beam, the optical system comprising:
a light source, adapted for providing an elliptical light beam defining different diverging angles in different directions, wherein any cross-section of the elliptical light beam emitted from the light source defines a long axis and a short axis which are perpendicular to each other;
a first lens, configured for collimating the elliptical light beam into a parallel elliptical light beam;
a second lens, configured as a diverging lens in directions corresponding to the short axis, for diverging the elliptical light beam and enlarging the short axis so as to narrow a difference between the long axis and the short axis and to narrow a difference between a diverging angle corresponding to the short axis and a diverging angle corresponding to the long axis, when the elliptical light beam passes therethough; and
a third lens, configured as a converging lens in the directions corresponding to the short axis, for converging the elliptical light beam and adjusting the short axis in order to obtaining a round light beam,
wherein the optical centers of the first lens, the second lens and the third lens commonly define a common optical axis along which the elliptical light beams travels;
a beam splitter, allowing light beams from a first direction to pass therethrough and for reflecting light beams from a second direction, the second direction being substantially opposite to the first direction;
an object lens for focusing parallel light beams to a point on an optical disk;
a collimator for collimating light beams passed therethrough; and
an optoelectronic detector, for receiving a light beam, detecting information from the light beam, converting the information into electronic signals, and outputting the electronic signals,
wherein the optical system, the beam splitter, the object lens, the collimator, and the optoelectronic detector are configured in a light path, so as to allow the round parallel light beam outputted from the optical system passes through the beam splitter, then is focused by the object lens onto a focal plane; then the focal plane reflects the focused light beam back to the object lens; the focused light beam is reverted by the object lens and incidents to round parallel light; then the beam splitter reflects the light beam to the collimator; and the collimator collimates the light beam to the optoelectronic detector.

10. An optical device for reading/writing to an optical disk, comprising:
an optical system comprising a light source emitting an elliptical diverging light beam, and at least a Fresnel lens, wherein the optical system outputs a substantially round light beam;
a beam splitter, allowing light beams from a first direction to pass therethrough and for reflecting light beams from a second direction, the second direction being substantially perpendicular to the first direction;
an object lens for focusing parallel light beams to a point on the optical disk;
a collimator for collimating light beams passed therethrough; and
an optoelectronic detector, for receiving a light beam, detecting information from the light beam, converting the information into electronic signals, and outputting the electronic signals,
wherein the optical system, the beam splitter, the object lens, the collimator and the optoelectronic detector are set in a manner that the round light beam outputted from the optical system travels in a sequence of the beam splitter, the object lens, the object lens, the beam splitter, the collimator, and the optoelectronic detector, in which the light beam outputted from the object lens is reflected by external reflective means of the optical disk back to the object lens.
